(19) United States
(12) Patent Application Publication
(10) Pub. No.: US 2015/0234201 A1
(43) Pub. Date: Aug. 20, 2015

(54) Magnetic Retention System

(71) Applicant: David J. Levesque, Assonet, MA (US)

(72) Inventor: David J. Levesque, Assonet, MA (US)

(21) Appl. No.: 14/617,369

(22) Filed: Feb. 9, 2015

Related U.S. Application Data
(60) Provisional application No. 61/940,473, filed on Feb. 16, 2014.

(51) Int. Cl. G02C 3/00; G02C 11/00; G02C 5/14

(52) U.S. Cl. CPC G02C 3/00; G02C 5/14; G02C 11/00; G02C 2200/02

(57) ABSTRACT

A magnetic retention system (MRS) for magnetically holding parts, such as an eyewear temple part is provided. The MRS includes a positioning subassembly having a ferromagnetic backing plate and a neodymium magnet, wherein the neodymium magnet is adaptable to magnetic communication with the backing plate. The MRS also includes a retention subassembly having a ferromagnetic retainer adaptable to magnetic communication with the neodymium magnet.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:
1. United States provisional patent application 61/940,473 entitled “Invisible Magnetic Eyeglass Holder”, naming David J. Levesque as inventor, filed 16 Feb. 2014.

### BACKGROUND

1. Field of Use

The present invention is directed to eyeglasses holders and more particularly to magnetic eyeglass holders.

2. Description of Prior Art (Background)

Typical eyeglasses consist of a frame body that houses two lenses on either side of a nose piece. Attached to the frame body are two temple bars that extend from two ends of the frame body. The temple bars pivot between an open position perpendicular with the frame body and a closed position parallel with the frame body. Sometimes attached to the temple bars are separate ear pieces, or temple tips. The temple bars and nose piece support the frame on the head of the wearer.

Individuals often remove their eyeglasses during the course of the day. They may hang them around their neck where they bounce against their chest, they may put them in a pocket and have them fall out or they may put them in a place where they can get damaged. Especially when individuals go to bed at night, they may put down their eyeglasses somewhere and not recall where the next morning when they need them.

To solve this problem, the prior art teaches a variety of eyeglass holders, including stand-alone and eyeglass holders which are fixed to a solid surface.

The use of magnets on eyeglass frames for various purposes is also well known in the art. For example, a number of eyeglass frames have magnets that magnetize the wearer for health benefits. Other eyeglass frames use magnets to hold eyeglass frame sections together, thereby facilitating disassembly and reassembly in a new configuration, with auxiliary frames, lenses, or the like.

Cords or chains that attach to the eyeglass temples and are worn around the neck are the most typical present devices. Such devices are disclosed in U.S. Pat No 5,956,812 also U.S. Pat. No. 4,136,934 and many others. These are unsatisfactory for many reasons. Namely, when the glasses are being held they are awkward and uncomfortable, especially when the wearer is in motion. If the chain or cord is kept attached to the glasses, it is very uncomfortable while wearing. If you take the chain off and on it is a nuisance and a storage problem, especially if you need the glasses to find and install the temple attachments. Metal and mechanical holders that are fitted in the pocket are awkward and unattractive and tend to pull the pocket down because of the weight of the glasses and the attachment. Some examples are shown in U.S. Pat. Nos. 5,842,613, 56,999,901 5.839,708, 5,864,924, 5,794,312, 5,860,191. Another method shown is the use of a pin attachment, such as in U.S. Pat. No. 4,458,384. This solution is undesirable because it damages the fabric to which it is attached. Adhesive attachment is not satisfactory because the adhesive always leaves a trace that attracts and accumulates dirt.

Another device disclosed in U.S. Pat. No. 6,367,126 merely places a magnetic loop holding element on top of a garment and juxtaposes a keeper underneath that will instantly damp the holder to the fabric, at which time, the temple of the eyeglass is inserted in the holding loop area provided. This solution is undesirable because it requires the user to look at the holding loop in order to insert the eyeglass temple into the holding loop, thus requiring a certain amount of dexterity and visual acuity not always possessed by a user, for example an aged or arthritic user; similar to threading the eye of a needle, a potentially dangerous proposition if driving or the like. In addition, this solution does not address the needs of an active user in that the temple can easily fall out of the loop holder if the user is jumping or running.

### BRIEF SUMMARY

This invention allows the user to instantaneously attach and detach eyewear from anywhere on any type of clothing, holding the eyewear securely on the garment during most daily activities. It consists of a base unit of one or two neodymium magnets placed by the user on opposite sides of a clothing article of either an undergarment or outer garment, and an article of fashion jewelry created from a ferrous or ferromagnetic metal bead, rube or plate uniquely designed to attach to the temple arm of the eyewear. The magnetic attraction of the base magnets and the jewelry piece secures the eyewear in place with the one or two neodymium magnets.

In accordance with one embodiment of the present invention a magnetic retention system (MRS) is provided. The MRS includes a positioning subassembly, having a ferromagnetic backing plate and a neodymium magnet, wherein the neodymium magnet is adaptable to magnetic communication with the backing plate. The MRS also includes a retention subassembly adaptable to affixing to a piece or part. The retention subassembly includes a ferromagnetic retainer adaptable to magnetic communication with the neodymium magnet.

The invention is also directed towards a magnetic eyewear retention system (MERS). The MERS includes a positioning subassembly having a ferromagnetic backing plate and a neodymium magnet, wherein the neodymium magnet is adaptable to magnetic communication with the backing plate. The ME RS also includes a retention subassembly, having a ferromagnetic retainer adaptable to magnetic communication with the neodymium magnet. The MERS also includes an eyewear temple part, wherein the retention subassembly is attachable to the eyewear temple part.

The invention is also directed towards an magnetic eyewear temple part retention system (METPRS). The METPRS includes a positioning subassembly having a ferromagnetic backing plate and a neodymium magnet, wherein the first neodymium magnet is adaptable to magnetic communication with the backing plate. The METPRS includes an eyewear temple part in addition to a retention subassembly. The retention subassembly includes a ferromagnetic retainer adaptable to magnetic communication with the neodymium magnet. The ferromagnetic retainer includes a ferromagnetic stem attachment tube having opposite openings. The retention subassembly also includes a continuous elastic cord, wherein the continuous elastic cord is disposed internally within the ferromagnetic stem attachment tube and wherein the continuous elastic cord comprises a first elastic loop external to the ferromagnetic stem attachment tube and a second elastic loop external to the ferromagnetic stem attachment tube and distal to the first elastic loop. The first elastic loop and the second elastic loop encircle the eyewear temple part.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a pictorial illustration of the magnetic retention system in accordance with the present invention;

FIG. 1A is a pictorial illustration of one embodiment of the magnetic retention system in accordance with the invention shown in FIG. 1;

FIG. 2A is a pictorial illustration of one embodiment of the magnetic retention system in accordance with the invention shown in FIG. 1;

FIG. 2B is a pictorial illustration of an alternate embodiment of the magnetic retention system in accordance with the invention shown in FIG. 1;

FIG. 2C is a pictorial illustration of an alternate embodiment of the magnetic retention system in accordance with the invention shown in FIG. 1;

FIG. 2C1 is a cross-cut view of the retention system shown in FIG. 2C;

FIG. 2C2 is an alternate cross-cut view of the retention system shown in FIG. 2C;

FIG. 3 is a pictorial illustration of the present invention showing one example of operational use with a pair of eyeglasses;

FIG. 4 is a pictorial illustration of an alternate stem attachment of the present invention shown in FIG. 1;

FIG. 4A is a pictorial illustration of the alternate stem attachment shown in FIG. 4 in an exemplary use;

FIG. 5A is a pictorial illustration of the magnetic retention system used with a pair of eyeglasses (open view) in accordance with the present invention shown in FIG. 1;

FIG. 5B is a pictorial illustration of the magnetic retention system used with a pair of eyeglasses (closed view) in accordance with the present invention shown in FIG. 1;

FIG. 6 is a pictorial illustration of an alternate magnetic keeper plate attached to an eyewear temple stem; and

FIG. 7 is a pictorial illustration of the present invention in operational use in accordance with the present invention shown in FIG. 1.

### DETAILED DESCRIPTION

The following brief definition of terms shall apply throughout the application:

The term “outer” or “outside” refers to a direction away from a user, while the term “inner” or “inside” refers to a direction towards a user;

The term “comprising” means including but not limited, to, and should be interpreted in the manner it is typically used in the patent context;

The term “magnetic communication” means magnetically attracted or magnetically affixed;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

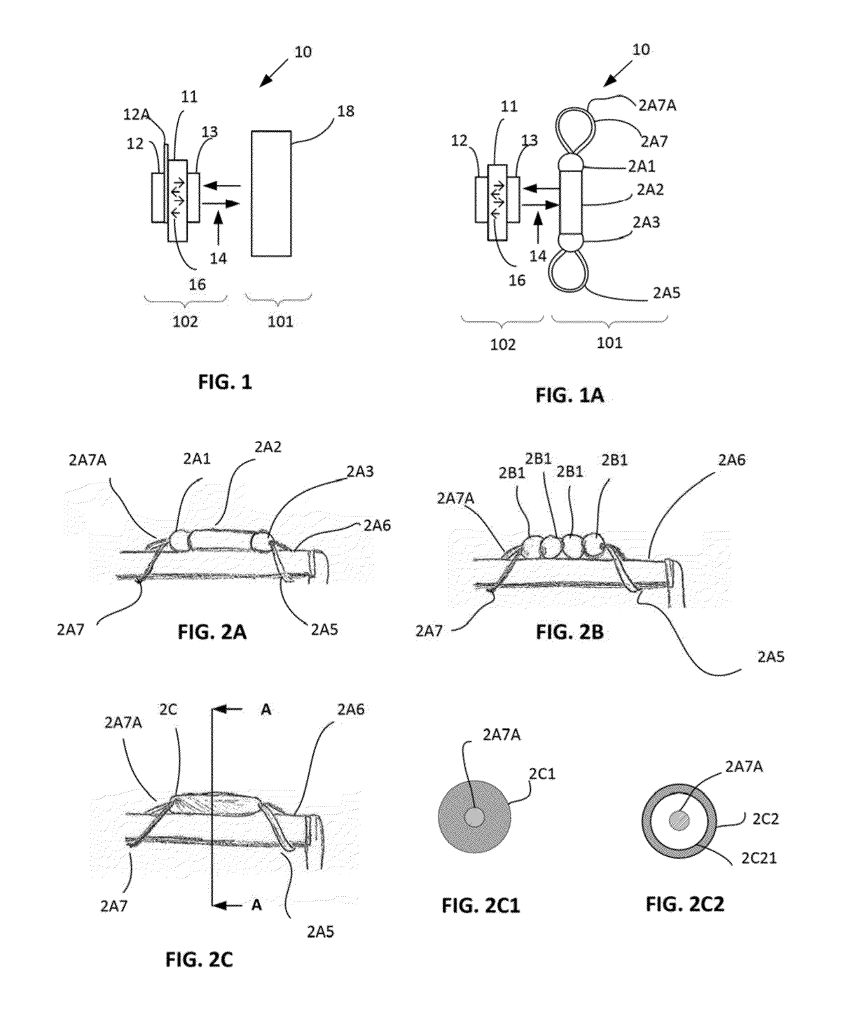

Referring now to FIG. 1, there is shown a pictorial illustration of the magnetic retention system (MRS) 10 in accordance with the present invention. The MRS 10 includes positioning subassembly 102 and retention subassembly 101. Positioning subassembly 102 includes: backing plate 12 and magnet 13. Position subassembly 102 also includes quick release tab 12A. Retention subassembly 101 includes ferromagnetic retainer 18.

Referring also to FIG. 1A. In this embodiment retention subassembly 101 includes first bead 2A1, a second bead 2A3, stem attachment tube 2A2, a first elastic loop 2A5, and a second elastic loop 2A7.

Still referring to FIG. 1, backing plate 12 may be any suitable ferromagnetic material such as, but not limited to, ferromagnetic metal, hybrid ferromagnetic plastics, a magnet such as a neodymium magnet or any suitable magnetically saturable keeper plate. Tube 2A2 may likewise be any suitable ferromagnetic material such as, but not limited to, ferromagnetic metal, hybrid ferromagnetic plastics, or a magnet such as a neodymium magnet. Magnet 13 may be any suitable magnet such as, for example, a neodymium magnet. The first elastic loop 2A5 and the second elastic loop 2A7 may be any suitable cord like material such as an elastic loop 2A7A. It will be appreciated that the first elastic loop 2A5 and the second elastic loop 2A7 may be independent loops affixed internal to the tube 2A2 or may comprise opposite ends of the same loop threaded through the tube 2A2. First bead 2A1 may be any suitable bead for preventing loop 2A7 from being pulled through tube 2A2. First bead 2A1 may also comprise ferromagnetic material. Likewise, second bead 2A3 may be any suitable bead for preventing loop 2A5 from being pulled through tube 2A2. Second bead 2A3 may also comprise ferromagnetic material.

Still referring to FIG. 1, the MRS operates by affixing retaining loops 2A7 and 2A5 over or around an item such as, for example, an eyeglass stem (shown later). The backing plate 12 and magnet 13 are place on opposite sides of an article 11, such as a piece of clothing, where it is desired to hold the item. It will be understood that backing plate 12 and magnet 13 are held in place by magnetic flux 16. Similarly tube 2A2 is held in place with magnet 13 by magnetic flux 14. It will be further understood that backing plate 12 may also be a magnet thereby increasing holding or retention force. In addition quick release tab 12A may be any suitable layer such as, for example, plastic, for facilitating removal of backing plate 12 from magnetic communication with magnet 13.

Referring also to FIG. 2A, there is shown a pictorial illustration of one embodiment of the magnetic retention system in accordance with the invention shown in FIG. 1. The MRS tube 2A2 is held to bar or tube 2A6 by retaining loops 2A7 and 2A5. As described earlier, MRS tube 2A2, and by extension, bar or tube 2A6, are held in place with magnet 13 by magnetic flux 14.

Referring also to FIG. 2B, there is shown a pictorial illustration of an alternate embodiment of the retention subassembly in accordance with the invention shown in FIG. 1. It will be appreciated that there may be any suitable number of ferromagnetic beads 2B1. It will also be appreciated that beads 2B1 may be magnetic. Still referring to FIG. 2B, elastic cord 2A7A is threaded through ferromagnetic beads 2B1 to form a ferromagnetic bead chain. The ferromagnetic bead chain, comprised of ferromagnetic beads 2B1, is attached via elastic loops 2A7 and 2A5

Referring also to FIG. 2C there is shown a pictorial illustration of an alternate embodiment of the magnetic retention system in accordance with the invention shown in FIG. 1. In this embodiment the retention subassembly comprises cylinder 2C. It will be appreciated that cylinder 2C may be any suitable ferromagnetic material and may be magnetic. Cylinder 2C encloses or encapsulates elastic cord 2A7A to form elastic loops 2A7 and 2A5 at either end of cylinder 2C.

Referring also to FIG. 2C1 and FIG. 2C2, there are shown alternate cross cut views of cylinder 2C. It will also be appreciated that ferromagnetic cylinder 2C may be substantially solid ferromagnetic material 2C1 enclosing elastic cord 2A7A. In an alternate embodiment, cylinder 2C1 may comprise a ferromagnetic cover 2C2 wrapped around a ferromagnetic or non-ferromagnetic material 2C21 enclosing elastic cord 2A7A.

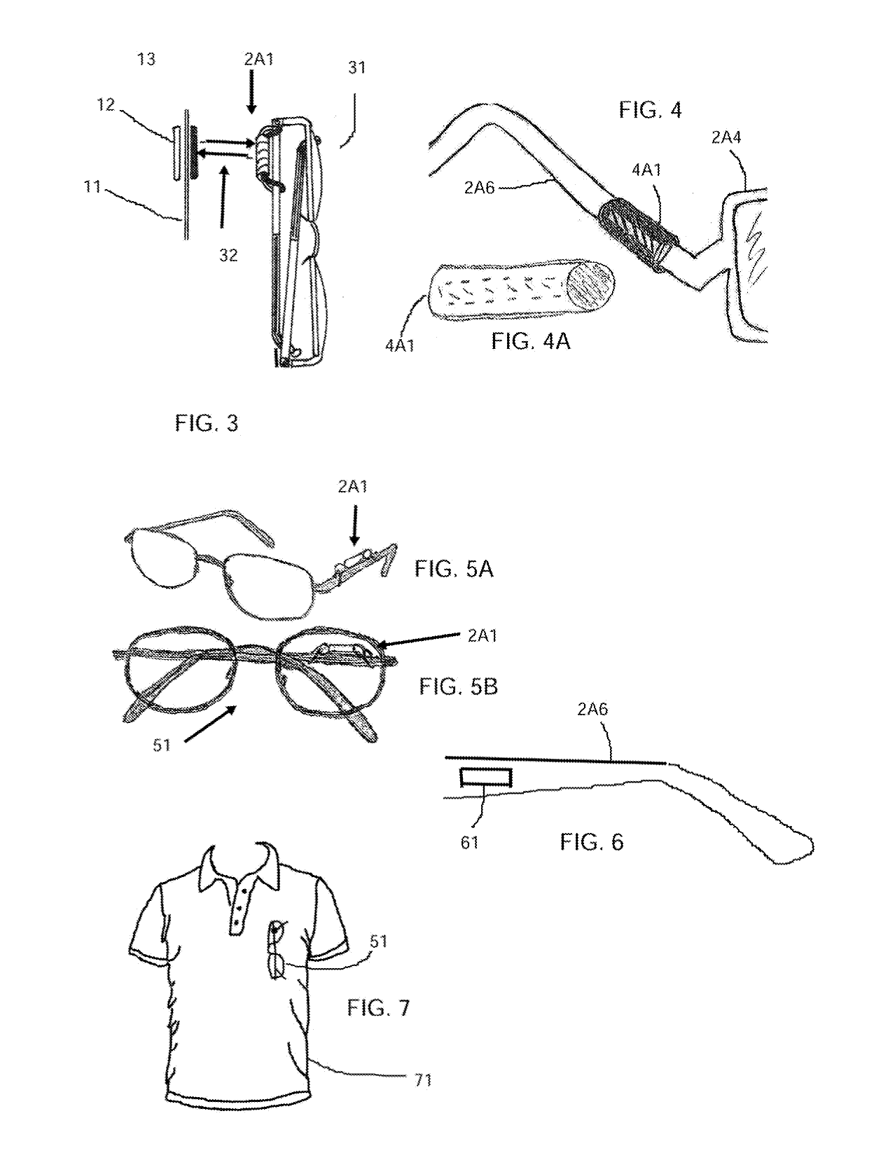

Referring also to FIG. 3 there is shown a pictorial illustration of the present invention showing one example of operational use with a pair of eyeglasses. In this example the MRS is used to hold a pair of eyeglasses 31 in place on article 11.

Referring also to FIG. 4 there is shown a pictorial illustration of an alternate retention subassembly shown in FIG. 1. In this embodiment the retention subassembly comprises a ferromagnetic metal rod or plate secured inside a stretch cloth tube, and stretched over the earpiece and slid up near the temple hinge or a coated ferromagnetic metal wire is wrapped securely around the temple portion of the glasses near the hinge.

FIG. 4A is a pictorial illustration of the alternate stern attachment shown in FIG. 4 in an exemplary use.

Referring also to FIGS. 5A and 5B there is shown a pictorial illustration of the magnetic retention system used with a pair of eyeglasses (open view) and eyeglasses (closed view) respectively, in accordance with the present invention shown in FIG. 1.

Referring also to FIG. 6 there is shown a pictorial illustration of a keeper plate 61 attached to an eyewear temple part 2A6. Keeper plate 61 may be any suitable ferromagnetic material. Keeper plate 61 may be affixed to temple stem 2A6 by any suitable method such as lamination, gluing, or mechanically affixing. It will be appreciated that keeper plate may be jewelry grade ferromagnetic metal or a magnet such as a neodymium magnet.

It should be understood that the foregoing description is only illustrative of the invention. Thus, various alternatives and modifications can be devised by those skilled in the art without departing from the invention. The foregoing and other problems are overcome, and other advantages are realized, in accordance with the presently preferred embodiments of these teachings. An eyeglass retention system featuring a non-invasive, removable and reusable eyeglass retention for use on apparel, is shown and described. There are no cords or chains attached to the eyeglasses, which are in the way and uncomfortable when the glasses are worn over the ears. The glasses do not jostle when walking or moving. There are no holes to be made in fine fabrics with the use of pins. There is no dependency on the availability of a pocket or button. Nor does the system require the user to thread the eyeglass temple through a loop.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Finally, it will be understood that use of broader terms such as comprises, includes, and having should be understood to provide support for narrower terms such as consisting of, consisting essentially of and comprised substantially of Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A magnetic retention system comprising:
a positioning subassembly, wherein the positioning subassembly comprises:
a ferromagnetic backing plate;
a neodymium magnet, wherein the neodymium magnet is adaptable to magnetic communication with the backing plate; and
a retention subassembly, wherein the retention subassembly comprises:
a ferromagnetic retainer adaptable to magnetic communication with the neodymium magnet.

2. The magnetic retention system as in claim 1 wherein the retention subassembly comprises:
a ferromagnetic stem attachment tube haying opposite openings;
a first continuous elastic cord, wherein the first continuous elastic cord is disposed internally within the ferromagnetic stein attachment tube and wherein the first continuous elastic cord comprises:
a first elastic loop external to the ferromagnetic stem attachment tube; and
a second elastic loop external to the ferromagnetic stem attachment tube and distal to the first elastic loop.

3. The magnetic retention system as in claim 2 further comprising:
a first bolding bead, wherein the first holding bead is removably affixed to one end of the ferromagnetic stem attachment tube;
a second holding bead, wherein the second holding bead is removably affixed to an opposite end of the ferromagnetic stem attachment tube where the first holding bead is removably attached,

4. The magnetic retention system as in claim 3 wherein the first holding bead and the second holding bead are each ferromagnetic.

5. The magnetic retention system as in claim 3 wherein the first holding bead and the second holding bead are removably affixed to the ferromagnetic stem attachment tube to form the first elastic loop and the second elastic loop, respectfully.

6. The magnetic retention system as in claim 1 further comprising a quick release tab disposed between the ferromagnetic backing plate and the neodymium magnet.

7. The magnetic retention system as in claim 1 wherein the retention subassembly comprises:
a plurality of ferromagnetic beads;
a second continuous elastic cord, wherein the second continuous elastic cord is threaded through the plurality of ferromagnetic beads, and wherein the second continuous elastic cord comprises:
a third elastic loop external to the plurality of ferromagnetic beads; and
a fourth elastic loop external to the plurality of ferromagnetic beads and distal to the third elastic loop.

8. The magnetic retention system as in claim 1 wherein the retention subassembly comprises:
a substantially solid ferromagnetic cylinder;
a third continuous elastic cord, wherein the third continuous elastic cord is threaded through the substantially solid ferromagnetic cylinder, and wherein the third continuous elastic cord comprises:
a fifth elastic loop external to the substantially solid ferromagnetic cylinder; and
a six elastic loop external to the substantially solid ferromagnetic cylinder and distal to the fifth elastic loop.

9. The magnetic retention system as in claim 1 wherein the retention subassembly comprises:
a ferromagnetic material; and
an elastic tube, wherein the elastic tube is juxtaposed with the ferromagnetic material.

10. A magnetic eyewear retention system comprising:
a positioning, subassembly, wherein the positioning subassembly comprises:
a ferromagnetic backing plate;
a first neodymium magnet, wherein the first neodymium magnet is adaptable to magnetic communication with the backing plate;
a retention subassembly, wherein the retention subassembly comprises:
a ferromagnetic retainer adaptable to magnetic communication with the neodymium magnet; and
an eyewear temple part, wherein the retention subassembly is attached to the eyewear temple part.

11. The magnetic eyewear retention system as in claim 10 wherein the retention subassembly comprises a ferromagnetic plate affixed to the eyewear temple part.

12. The magnetic eyewear retention system as in claim 10 wherein the retention subassembly comprises a ferromagnetic wire affixed to the eyewear temple part.

13. The magnetic retention system as in claim 10 further comprising a quick release tab disposed between the ferromagnetic backing plate and the neodymium magnet.

14. The magnetic retention system as in claim 10 wherein the retention subassembly comprises:
a ferromagnetic stem attachment tube having opposite openings;
a first continuous elastic cord, wherein the first continuous elastic cord is disposed internally within the ferromagnetic stem attachment tube and wherein the first continuous elastic cord comprises:
a first elastic loop external to the ferromagnetic stem attachment tube;
a second elastic loop external to the ferromagnetic stem attachment tube and distal to the first elastic loop;
and wherein the first elastic loop and the second elastic loop encircle the eyewear temple part.

15. The magnetic retention system as in claim 14 further comprising:
a first holding bead, wherein the first holding bead is removably affixed to one end of the ferromagnetic stem attachment tube;
a second holding bead, wherein the second holding bead is removably affixed to an opposite end of the ferromagnetic stem attachment tube where the first holding bead is removably attached.

16. The magnetic retention system as in claim 14 wherein the first holding bead and the second holding bead are each ferromagnetic.

17. The magnetic retention system as in claim 14 wherein the first holding bead and the second holding bead are removably affixed to the ferromagnetic stem attachment tube to form the first elastic loop and the second elastic loop, respectfully.

18. The magnetic retention system as in claim 13 wherein the ferromagnetic backing plate comprises a second neodymium magnet.

19. A magnetic eyewear temple part retention system comprising:
a positioning subassembly, wherein the positioning subassembly comprises:
a ferromagnetic backing plate;
a first neodymium magnet, wherein the first neodymium magnet is adaptable to magnetic communication with the backing plate;
an eyewear temple part;
a retention subassembly, wherein the retention subassembly comprises:
a ferromagnetic retainer adaptable to magnetic communication with the neodymium magnet, wherein the ferromagnetic retainer comprises:
a ferromagnetic stem attachment tube having opposite openings;
a first continuous elastic cord, wherein the first continuous elastic cord is disposed internally within the ferromagnetic stem attachment tube and wherein the first continuous elastic cord comprises:
a first elastic loop external to the ferromagnetic stem attachment Tube;
a second elastic loop external to the ferromagnetic stem attachment tube and distal to the first elastic loop; and
wherein the first elastic loop and the second elastic loop encircle the eyewear temple part.

20. The magnetic eyewear temple part retention system as in claim 19, wherein the ferromagnetic backing plate comprises a second neodymium magnet.
